(19) United States
(12) Patent Application Publication
(10) Pub. No.: US 2022/0316281 A1
(43) Pub. Date: Oct. 6, 2022

(54) ELECTRICALLY CONDUCTIVE CERAMIC CONDUCTOR FOR DOWNHOLE APPLICATIONS

(71) Applicants: Farhat Shaikh, Houston, TX (US); Navin Sakthivel, Spring, TX (US); Aaron Avagliano, Tomball, TX (US); Wei Chen, Sugar Land, TX (US)

(72) Inventors: Farhat Shaikh, Houston, TX (US); Navin Sakthivel, Spring, TX (US); Aaron Avagliano, Tomball, TX (US); Wei Chen, Sugar Land, TX (US)

(73) Assignee: Baker Hughes Oilfield Operations LLC, Houston, TX (US)

(21) Appl. No.: 17/223,127

(22) Filed: Apr. 6, 2021

(51) Int. Cl. E21B 17/00; H01B 1/18; C04B 37/02; C04B 37/00

(52) U.S. Cl. CPC E21B 17/003; H01B 1/18; C04B 37/021; C04B 37/001; C04B 2237/407; C04B 2237/408; C04B 2237/363; C04B 2237/84

(57) ABSTRACT

An electrically conductive ceramic composite conductor configured for downhole operations includes a first portion formed from an electrically non-conductive ceramic material having a first coefficient of thermal expansion (CTE). The first portion includes an outer surface. A second portion is disposed radially inwardly of the outer surface. The second portion is formed from an electrically conductive ceramic material having a second CTE that is substantially similar to the first CTE.

### BACKGROUND

In the resource exploration and recovery industry through-feeds or bulkheads are used to pass electrical power across mechanical connections. In addition to providing an electrically conductive pathway, the through-feeds and bullheads also provide mechanical support and electrical insulation. There are a variety of solutions for passing electrical power across mechanical connections. Typically, through-feeds or bulkhead includes a metal conductor embedded in an insulating material. For example, metal-based conductors may be packed into polyether-ether-ketone (PEEK), glass, or other non-electrically conducting polymer sheaths. In other cases, a metal conductor may be brazed to a ceramic support.

PEEK, glass, and other polymer insulating materials while good for some applications possess a number of drawbacks in other applications. For example, PEEK, glass, and other polymers have heat restrictions that impose limits on how and where they may be used. Other materials, that are more suitable for use in high temperature environments such as ceramic, present manufacturing challenges. For example, brazing metal conductors to a ceramic substrate presents a number of issues including breakage, increased costs, and cracks that form in the ceramic during brazing.

The use of electrically conductive and electrically non-conductive ceramics would pose additional challenges. That is, electrically conductive and electrically non-conductive ceramics possess different coefficients of thermal expansion (CTE). Thus, when the components are sintered, and each component undergoes a dimension change at a different rate cracking occurs. The cracking degrades the structural integrity and therefore the usefulness of the conductor. Accordingly, the industry would welcome a through-feed or bulkhead that included an electrically conductive core surrounded by an insulating material that is easy to manufacture, cost effective and one which can withstand the high temperature and high pressures associated with a downhole environment.

### SUMMARY

Disclosed is an electrically conductive ceramic composite conductor configured for downhole operations includes a first portion formed from an electrically non-conductive ceramic material having a first coefficient of thermal expansion (CTE). The first portion includes an outer surface. A second portion is disposed radially inwardly of the outer surface. The second portion is formed from an electrically conductive ceramic material having a second CTE that is substantially similar to the first CTE.

Also disclosed is a method of forming a ceramic composite conductor for downhole applications including depositing a first portion formed from electrically non-conductive ceramic material having an outer surface on a substrate. The first portion possesses a first coefficient of thermal expansion (CTE). A second portion formed from an electrically conductive ceramic material is formed radially inwardly of the outer surface of the first portion. The second portion has a second CTE that is substantially similar to the first CTE. The first portion and the second portion are cured to form the ceramic composite conductor for a downhole tool.

### BRIEF DESCRIPTION OF THE DRAWINGS

The following descriptions should not be considered limiting in any way. With reference to the accompanying drawings, like elements are numbered alike:

FIG. 1 depicts a resources exploration and recovery system including an electrically conductive ceramic composite conductor, in accordance with a non-limiting example;

FIG. 2 depicts a resistive imaging pad including a plurality of electrically conductive ceramic composite conductor, in accordance with a non-limiting example;

FIG. 3 depicts a perspective view of an electrically conductive ceramic composite conductor, in accordance with a non-limiting example;

FIG. 4 depicts a cross-sectional side view of the electrically conductive ceramic composite conductor of FIG. 3 taken through the line 3-3, in accordance with a non-limiting example;

FIG. 5 depicts a perspective view of an electrically conductive ceramic composite conductor of FIG. 3, in accordance with a non-limiting example;

FIG. 6 a cross-sectional side view of the electrically conductive ceramic composite conductor of FIG. 5, in accordance with a non-limiting example;

FIG. 7 depicts an electrically conductive ceramic composite conductor being formed through an additive manufacturing process, in accordance with a non-limiting example;

FIG. 8 depicts an electrically conductive ceramic material being deposited into a passage formed in an electrically non-conductive ceramic material layer, in accordance with a non-limiting example;

FIG. 9 depicts an electrically non-conductive ceramic material portion of an electrically conductive ceramic composite conductor formed in accordance with another aspect of a non-limiting example;

FIG. 10 depicts an electrically conductive ceramic material being deposited into a central passage of the electrically non-conductive ceramic material portion of FIG. 9, in accordance with a non-limiting example;

FIG. 11 depicts an electrically non-conductive ceramic material portion of an electrically conductive ceramic composite conductor formed in accordance with yet another a non-limiting example; and

FIG. 12 depicts an electrically conductive ceramic material portion being formed on a central portion of the electrically non-conductive ceramic material portion of then electrically conductive ceramic composite conductor shown in FIG. 11, in accordance with a non-limiting example.

### DETAILED DESCRIPTION

A detailed description of one or more embodiments of the disclosed apparatus and method are presented herein by way of exemplification and not limitation with reference to the Figures.

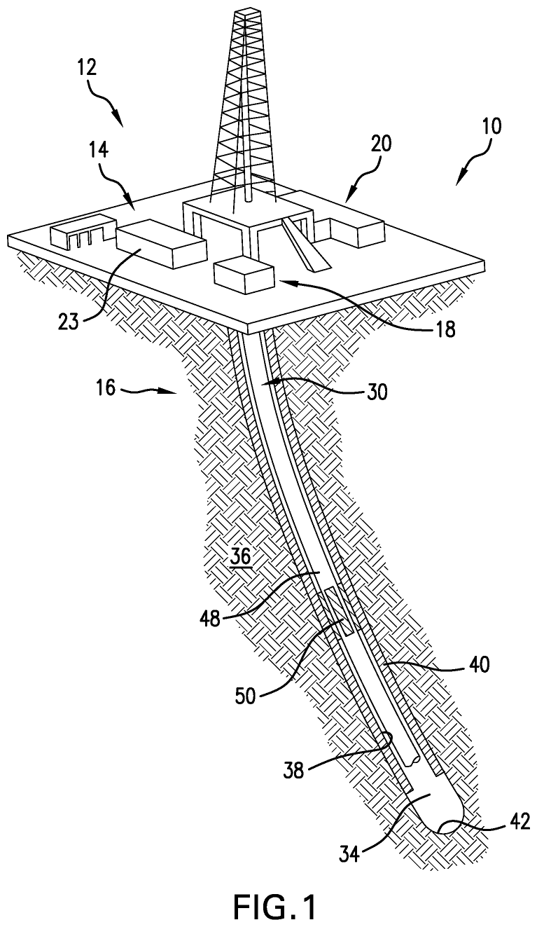

A resource exploration and recovery system, in accordance with a non-limiting example, is indicated generally at 10 in FIG. 1. Resource exploration and recovery system 10 should be understood to include well drilling operations, resource extraction and recovery, CO₂ sequestration, and the like. Resource exploration and recovery system 10 may include a first system 12 which, in some environments, may take the form of a surface system 14 operatively and fluidically connected to a second system 16 which, in some environments, may take the form of a subsurface system.

First system 12 may include pumps 18 that aid in completion and/or extraction processes as well as fluid storage 20. Fluid storage 20 may contain a stimulation fluid which may be introduced into second system 16. First system 12 may also include a control system 23 that may monitor and/or activate one or more downhole operations. Second system 16 may include a tubular string 30 formed from one or more tubulars (not separately labeled) that is extended into a wellbore 34 formed in an earth formation 36. Wellbore 34 includes an annular wall 38 that may be defined by a casing tubular 40 that extends from first system 12 towards a toe 42 of wellbore 34.

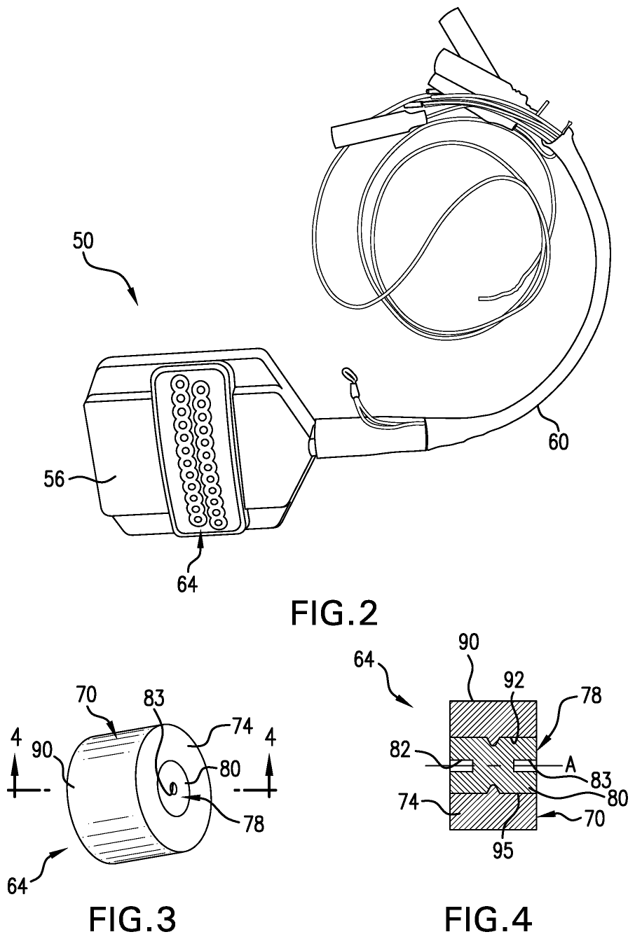

In a non-limiting example, tubular string 30 includes an outer surface 48 to Which is attached the downhole tool which may take the form of a plurality of resistive imaging pads, one of which is indicated at 50. As shown in FIG.2, each resistive imaging pad 50 includes a body 56 having an electrical conductor 60 that may provide an interface between control system 23 and a plurality of electrically conductive ceramic composite conductors 64 embedded in body 56 and in contact with outer surface 48. Resistive imaging pads 50 may be employed in conjunction with a resistive imaging system (not shown) that senses parameters of fluid passing through tubular string 30.

Referring to FIGS. 3 and 4, each electrically conductive ceramic composite conductor 64 includes a first portion 70 formed from an electrically non-conductive or insulating ceramic material 74 and a second portion 78 formed from an electrically conductive ceramic material 80. Electrically conductive ceramic material may be infused with electrically conductive particles. In a non-limiting example, the electrically conductive particles may represent nano-sized silver (Ag) particles. In another non-limiting example, the electrically conductive particles may be nano-sized graphene particles. In yet another non-limiting example, the electrically conductive particles may take the form of nano-sized copper (Cu) particles, nano-sized platinum (Pt) particles, and/or nano-sized gold (Au) particles, alloys thereof or the like. It should be understood that the size and type of the electrically conductive particles may of course vary.

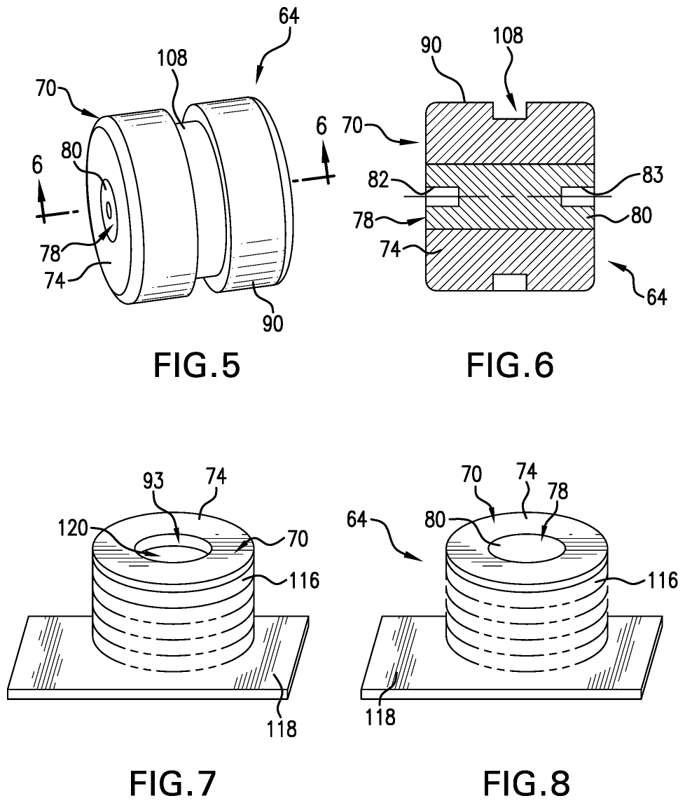

In a non-limiting example, second portion 78 includes a first recess 82 that extends along a central longitudinal axis “A” of electrically conductive ceramic composite conductor 64 in a first direction and a second recess 83 that extends along the central longitudinal axis “A” in a second, opposing direction. First portion 70 includes an outer surface 90 which, in the embodiment shown, is annular, and an inner surface 92 that may form a passage 93 (FIG. 7). Second portion 78 may be arranged in passage 93 and includes an outer surface portion 95 that is bonded to inner surface 92. FIGS. 5 and 6, wherein like reference numbers represent corresponding parts in the respective views, shows an annular channel 108 projecting radially inwardly of outer surface 90. Annular channel 108 may provide increased surface area so as to promote a stronger bond to, for example, body 56 of resistive imaging pad 50.

In accordance with a non-limiting example, electrically non-conductive ceramic material 74 possesses a first coefficient of thermal expansion (CTE). Electrically conductive ceramic material 80 possesses a second CTE that is substantially identical to the first CTE. As will be detailed herein, matching the CTE of electrically non-conductive ceramic material 74 and the CTE of electrically conductive ceramic material 80 ensures a substantially similar rate of expansion during a curing process, such as sintering. Ensuring the similar rate of expansion reduces a likelihood that one, the other or both of electrically non-conductive ceramic material 74 and electrically conductive ceramic material 80 will crack when being cured.

Reference will now follow to FIGS. 7 and 8, with continued reference to FIGS. 3 and 4 in describing a method of forming electrically conductive ceramic composite conductor 64 in accordance with a non-limiting example. Electrically conductive ceramic composite conductor 64 is formed from a plurality of layers, one of which is indicated at 116, built up upon a substrate 118 as shown in FIG. 7. Layers 116 are formed on substrate 118 and upon previous layers 116 in an additive manufacturing process. Electrically non-conductive ceramic material 74 is formed as a disc (not separately labeled) including a void that in a non-limiting example, may take the form of a central opening 120 which may define a portion of passage 93. At this point, electrically conductive ceramic material 80 is deposited in central opening 120 as shown in FIG. 8. Layers 116 are built up forming a multi-layer blank (not separately labeled) having a selected height. The multi-layer blank is then cured, such as through sintering, to form electrically conductive ceramic composite conductor 64.

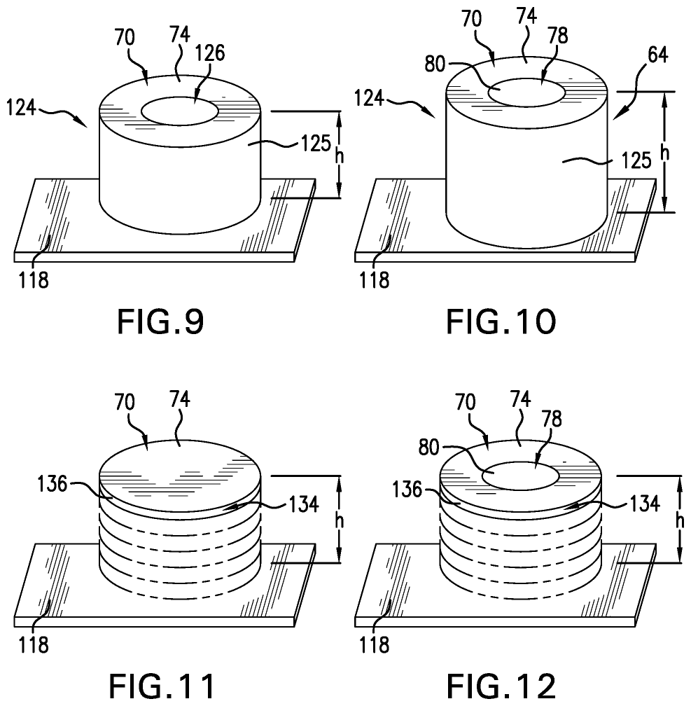

Reference will now follow to FIGS. 9 and 10, with continued reference to FIGS. 3 and 4 in describing another method of forming electrically conductive ceramic composite conductors 64 in accordance with a non-limiting example. As seen in FIG. 9, a shell 124 is formed from electrically non-conductive ceramic material 67. Shell 124 includes an outer surface 125 and a passage 126 arranged radially inwardly of outer surface 125. Shell 124 has a height “h” that is close to a selected height for electrically conductive ceramic composite conductor 64. That is, the size of shell 124 is adjusted for any dimensional changes that may occur during curing. Once shell 124 is formed, passage 126 is filled with electrically conductive ceramic material 80 that could take the form of a powder or a gel as shown in FIG. 10. At this point, the blank goes through a curing process, such as sintering, to form electrically conductive ceramic composite conductor 64.

Reference will now follow to FIGS. 11 and 12 in describing yet another method of forming electrically conductive ceramic composite conductors 64 in accordance with a non-limiting example. As shown in FIG. 11, a blank (not separately labeled) is formed from a plurality of layers 134. Layers 134 are started on substrate 118 and built upon previous layers 134 to a selected height “h”. Each layer 134 starts off as a disc having an outer surface 136 formed from electrically non-conductive ceramic material 74. Once layer 134 is formed, an amount of electrically conductive dopant, in the form of electrically conductive nano-sized particles, is added to electrically non-conductive ceramic material 74 radially inwardly of outer surface 136 as shown in FIG. 12. In this manner, a portion of electrically non-conductive ceramic material 74 is transformed to be electrically conductive. Additional layers 134 are added until a blank is formed having a selected height. The blank is cured, such as through sintering, to form electrically conductive ceramic composite conductor 64.

At this point, it should be understood that non-limiting examples include an electrically conductive ceramic composite conductor formed from two materials having substantially matching CTE's. One material forms an outer portion of the ceramic composite conductor and takes the form of an electrically non-conductive ceramic material. Another material forms an inner portion of the ceramic composite conductor and takes the form of an electrically conductive ceramic material.

The electrically conductive ceramic material is made conductive by adding, for example, a dopant in the form of electrically conductive nano-sized particles. The electrically conductive nano-sized particles may be added before forming or while forming the electrically conductive ceramic material. In this manner, the first material and the second material may be the same but for the addition of electrically conductive nano-sized particles. Regardless of how they are formed, substantially matching the CTE of both the electrically non-conductive ceramic and the electrically conductive ceramic material alleviates cracking problems which previously occurred during curing. The exemplary embodiment thereby represents a more cost effective, more robust, and resilient ceramic conductor that is easy to manufacture and which can readily stand up to downhole temperatures and pressures.

Set forth below are some non-limiting examples of the foregoing disclosure:

Embodiment 1. An electrically conductive ceramic composite conductor configured for downhole operations, the electrically conductive ceramic composite conductor comprising: a first portion formed from an electrically non-conductive ceramic material having a first coefficient of thermal expansion (CTE), the first portion including an outer surface; and a second portion disposed radially inwardly of the outer surface, the second portion being formed from an electrically conductive ceramic material having a second CTE that is substantially similar to the first CTE.

Embodiment 2. The electrically conductive ceramic composite conductor according to any prior embodiment, wherein the electrically conductive ceramic material includes a plurality of electrically conductive nano-sized particles.

Embodiment 3. The electrically conductive ceramic composite conductor according to any prior embodiment, wherein the plurality of electrically conductive nano-sized particles forms a dopant.

Embodiment 4. The electrically conductive ceramic composite conductor according to any prior embodiment, wherein the plurality of electrically conductive nano-sized particles comprise at least one of nano-sized silver particles, nano-sized copper particles, nano-sized platinum particles, and nano-sized gold particles.

Embodiment 5. The electrically conductive ceramic composite conductor according to any prior embodiment, wherein the plurality of electrically conductive nano-sized particles comprises graphene.

Embodiment 6. The electrically conductive ceramic composite conductor according to any prior embodiment, wherein the first portion includes an inner surface defining a passage, the second portion being arranged in the passage.

Embodiment 7. The electrically conductive ceramic composite conductor according to any prior embodiment, wherein the second portion is bonded to the inner surface.

Embodiment 8. A method of forming a ceramic composite conductor for downhole applications comprising: depositing a first portion formed from electrically non-conductive ceramic material having an outer surface on a substrate, the first portion possessing a first coefficient of thermal expansion (CTE); forming a second portion formed from an electrically conductive ceramic material radially inwardly of the outer surface of the first portion, the second portion having a second CTE that is substantially similar to the first CTE; and curing the first portion and the second portion to form the ceramic composite conductor for a downhole tool.

Embodiment 9. The method according to any prior embodiment, wherein depositing the first portion includes forming a first layer having a height that is less than a prescribed height of the electrically conductive ceramic composite conductor.

Embodiment 10. The method according to any prior embodiment, wherein forming the first layer includes forming a disc having the outer surface and an inner surface defining a void.

Embodiment 11. The method according to any prior embodiment, wherein forming the second portion includes placing the electrically conductive ceramic material in the void.

Embodiment 12. The method according to any prior embodiment, wherein forming the second portion includes placing the electrically conductive ceramic material onto the first layer radially inwardly of the outer surface.

Embodiment 13. The method according to any prior embodiment, wherein forming the second portion includes doping a section of the first portion with electrically conductive particles.

Embodiment 14. The method according to any prior embodiment, wherein doping the section of the first portion includes adding one or more of nano-sized silver particles, nano-sized copper particles, nano-sized platinum particles, and nano-sized gold particles to the section of the first portion.

Embodiment 15. The method according to any prior embodiment, wherein doping the section of the first portion includes adding nano-sized graphene particles to the portion of the first, electrically non-conductive ceramic material.

Embodiment 16. The method according to any prior embodiment, wherein depositing the first portion includes building a plurality of layers of the first, electrically non-conductive ceramic material to a height that is substantially equal to a prescribed height of the electrically conductive ceramic composite conductor.

Embodiment 17. The method according to any prior embodiment, wherein building the plurality of layers includes forming a shell having the outer surface and an inner surface defining a passage.

Embodiment 18. The method according to any prior embodiment, wherein forming the second portion includes filling the passage with the electrically conductive ceramic material.

Embodiment 19. The method according to any prior embodiment, wherein curing the first portion and the second portion includes drying the first portion and the second portion.

Embodiment 20. The method according to any prior embodiment, wherein curing the first portion and the second portion includes sintering the first portion and the second portion.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another.

The terms “about”, “substantially”, and “generally” are intended to include the degree of error associated with measurement of the particular quantity based upon the equipment available at the time of filing the application. For example, “about” and/or “substantially” and/or “generally” can include a range of ±8% or 5%, or 2% of a given value.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

1. An electrically conductive ceramic composite conductor, the electrically conductive ceramic composite conductor comprising:
a first portion formed from an electrically non-conductive ceramic material having a first coefficient of thermal expansion (CTE), the first portion including an outer surface; and
a second portion disposed radially inwardly of the outer surface, the second portion being formed from an electrically conductive ceramic material having a second CTE that is substantially similar to the first CTE.

2. The electrically conductive ceramic composite conductor according to claim 1, wherein the electrically conductive ceramic material includes a plurality of electrically conductive nano-sized particles.

3. The electrically conductive ceramic composite conductor according to claim 2, wherein the plurality of electrically conductive nano-sized particles forms a dopant.

4. The electrically conductive ceramic composite conductor according to claim 2, wherein the plurality of electrically conductive nano-sized particles comprise at least one of nano-sized silver particles, nano-sized copper particles, nano-sized platinum particles, and nano-sized gold particles.

5. The electrically conductive ceramic composite conductor according to claim 2, wherein the plurality of electrically conductive nano-sized particles comprises graphene.

6. The electrically conductive ceramic composite conductor according to claim 1, wherein the first portion includes an inner surface defining a passage, the second portion being arranged in the passage.

7. The electrically conductive ceramic composite conductor according to claim 6, wherein the second portion is bonded to the inner surface.

8. A method of forming a ceramic composite conductor comprising:
depositing a first portion formed from electrically non-conductive ceramic material having an outer surface on a substrate, the first portion possessing a first coefficient of thermal expansion (CTE);
forming a second portion formed from an electrically conductive ceramic material radially inwardly of the outer surface of the first portion, the second portion having a second CTE that is substantially similar to the first CTE; and
curing the first portion and the second portion to form the ceramic composite conductor for a downhole tool.

9. The method of claim 8, wherein depositing the first portion includes forming a first layer having a height that is less than a prescribed height of the electrically conductive ceramic composite conductor.

10. The method of claim 9, wherein forming the first layer includes forming a disc having the outer surface and an inner surface defining a void.

11. The method of claim 10, wherein forming the second portion includes placing the electrically conductive ceramic material in the void.

12. The method of claim 9, wherein forming the second portion includes placing the electrically conductive ceramic material onto the first layer radially inwardly of the outer surface.

13. The method of claim 9, wherein forming the second portion includes doping a section of the first portion with electrically conductive particles.

14. The method of claim 13, wherein doping the section of the first portion includes adding one or more of nano-sized silver particles, nano-sized copper particles, nano-sized platinum particles, and nano-sized gold particles to the section of the first portion.

15. The method of claim 13, wherein doping the section of the first portion includes adding nano-sized graphene particles to the portion of the first, electrically non-conductive ceramic material.

16. The method of claim 8, wherein depositing the first portion includes building a plurality of layers of the first, electrically non-conductive ceramic material to a height that is substantially equal to a prescribed height of the electrically conductive ceramic composite conductor.

17. The method of claim 16, wherein building the plurality of layers includes forming a shell having the outer surface and an inner surface defining a passage.

18. The method of claim 17, wherein forming the second portion includes filling the passage with the electrically conductive ceramic material.

19. The method of claim 8, wherein curing the first portion and the second portion includes drying the first portion and the second portion.

20. The method of claim 8, wherein curing the first portion and the second portion includes sintering the first portion and the second portion.
